(19) United States
(12) Patent Application Publication
(10) Pub. No.: US 2017/0201973 A1
(43) Pub. Date: Jul. 13, 2017

(54) MEASUREMENT GAP ALLOCATION

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/995,188

(22) Filed: Jan. 13, 2016

(51) Int. Cl. H04W 72/04; H04B 17/309; H04W 36/30; H04L 12/26

(52) U.S. Cl. CPC H04W 72/044; H04L 43/16; H04B 17/309; H04W 36/30

(57) ABSTRACT

A user equipment (UE) reduces delays associated with inter-radio access technology (IRAT) measurements. In one instance, the UE determines whether a first signal quality of a serving cell, a second signal quality of an intra frequency neighbor cell of a serving RAT (radio access technology), and/or a third signal quality of an inter frequency neighbor cell of the serving RAT is below a first threshold. The UE also determines whether a fourth signal quality of at least one cell of a neighbor RAT is above a second threshold. The UE further allocates one or more measurement gaps for a synchronization channel decoding procedure for the neighbor RAT based at least in part on the determining whether the fourth signal quality is above the second threshold and determining whether the first, second, and/or third signal quality is below the first threshold.

### BACKGROUND

Field

Aspects of the present disclosure relate generally to wireless communication systems, and more particularly, to allocating measurement gaps for inter-frequency measurements and inter-radio access technology measurements.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China employs TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but also to advance and enhance the user experience with mobile communications.

### SUMMARY

According to one aspect of the present disclosure, a method of wireless communication includes determining whether a first signal quality of a serving cell, a second signal quality of an intra frequency neighbor cell of a serving RAT (radio access technology), and/or a third signal quality of an inter frequency neighbor cell of the serving RAT is below a first threshold. The method also includes determining whether a fourth signal quality of at least one cell of a neighbor RAT is above a second threshold. The method also includes allocating measurement gap(s) for a synchronization channel decoding procedure for the neighbor RAT. The allocation is based on the determining whether the fourth signal quality is above the second threshold and on the determining whether the first, second, and/or third signal quality is below the first threshold.

According to another aspect of the present disclosure, an apparatus for wireless communication includes means for determining whether a first signal quality of a serving cell, a second signal quality of an intra frequency neighbor cell of a serving RAT (radio access technology), and/or a third signal quality of an inter frequency neighbor cell of the serving RAT is below a first threshold. The apparatus may also include means for determining whether a fourth signal quality of at least one cell of a neighbor RAT is above a second threshold. The apparatus may also include means for allocating measurement gap(s) for a synchronization channel decoding procedure for the neighbor RAT. The allocation is based on the determining whether the fourth signal quality is above the second threshold and on the determining whether the first, second, and/or third signal quality is below the first threshold.

Another aspect discloses an apparatus for wireless communication and includes a memory and at least one processor (e.g., one or more processors) coupled to the memory. The processor(s) is configured to determine whether a first signal quality of a serving cell, a second signal quality of an intra frequency neighbor cell of a serving RAT (radio access technology), and/or a third signal quality of an inter frequency neighbor cell of the serving RAT is below a first threshold. The processor(s) is also configured to determine whether a fourth signal quality of at least one cell of a neighbor RAT is above a second threshold. The processor(s) is also configured to allocate measurement gap(s) for a synchronization channel decoding procedure for the neighbor RAT. The allocation is based on the determining whether the fourth signal quality is above the second threshold and on the determining whether the first, second, and/or third signal quality is below the first threshold.

Yet another aspect discloses a computer program product for wireless communications in a wireless network having a non-transitory computer-readable medium. The computer-readable medium has non-transitory program code recorded thereon which, when executed by the processor(s), causes the processor(s) to determine whether a first signal quality of a serving cell, a second signal quality of an intra frequency neighbor cell of a serving RAT (radio access technology), and/or a third signal quality of an inter frequency neighbor cell of the serving RAT is below a first threshold. The program code also causes the processor(s) to determine whether a fourth signal quality of at least one cell of a neighbor RAT is above a second threshold. The program code further causes the processor(s) to allocate measurement gap(s) for a synchronization channel decoding procedure for the neighbor RAT. The allocation is based on the determining whether the fourth signal quality is above the second threshold and on the determining whether the first, second, and/or third signal quality is below the first threshold.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in long term evolution (LTE).

FIG. 3 is a diagram illustrating an example of an uplink frame structure in LTE.

FIG. 4 is a block diagram illustrating an example of a global system for mobile communications (GSM) frame structure.

FIG. 5 is a block diagram conceptually illustrating an example of a base station in communication with a user equipment (UE) in a telecommunications system.

FIG. 6 is a block diagram illustrating the timing of channel carriers according to aspects of the present disclosure.

FIG. 7 is a diagram illustrating network coverage areas according to aspects of the present disclosure.

FIG. 8 is a flow diagram illustrating an example decision process for search and measurement of neighbor cells.

FIG. 9 illustrates an exemplary discontinuous reception communication cycle.

FIG. 10 illustrates a timeline for measurement gaps allocated by a network and a synchronization timeline indicating arrival of channels for synchronizing a user equipment (UE) to a target radio access technology (RAT).

FIG. 11 is a flow diagram illustrating a method for allocating measurement gaps according to one aspect of the present disclosure.

FIG. 12 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

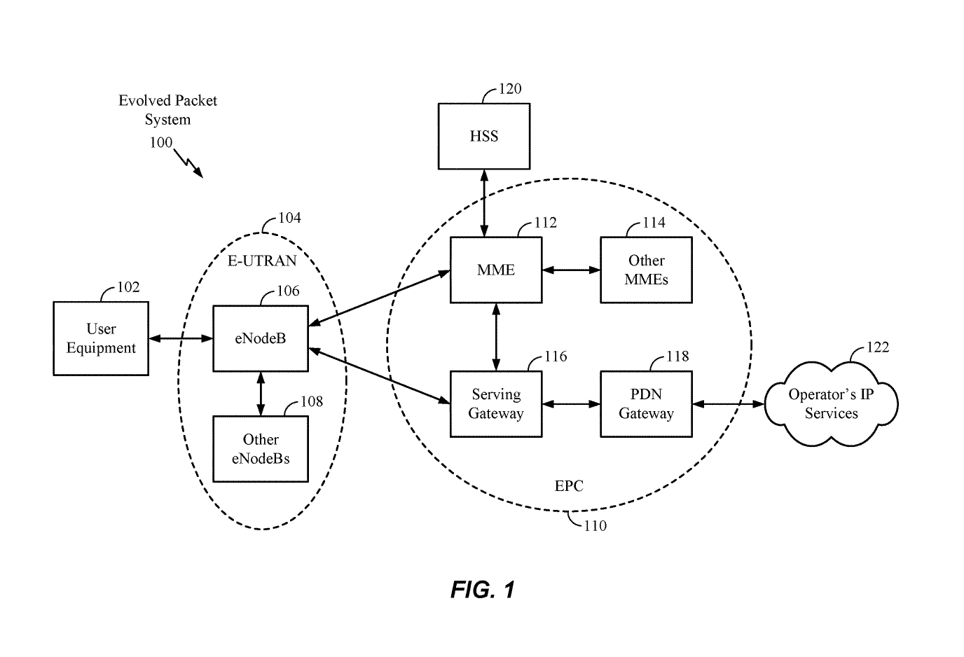

FIG. 1 is a diagram illustrating a network architecture 100 of a long term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity, those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

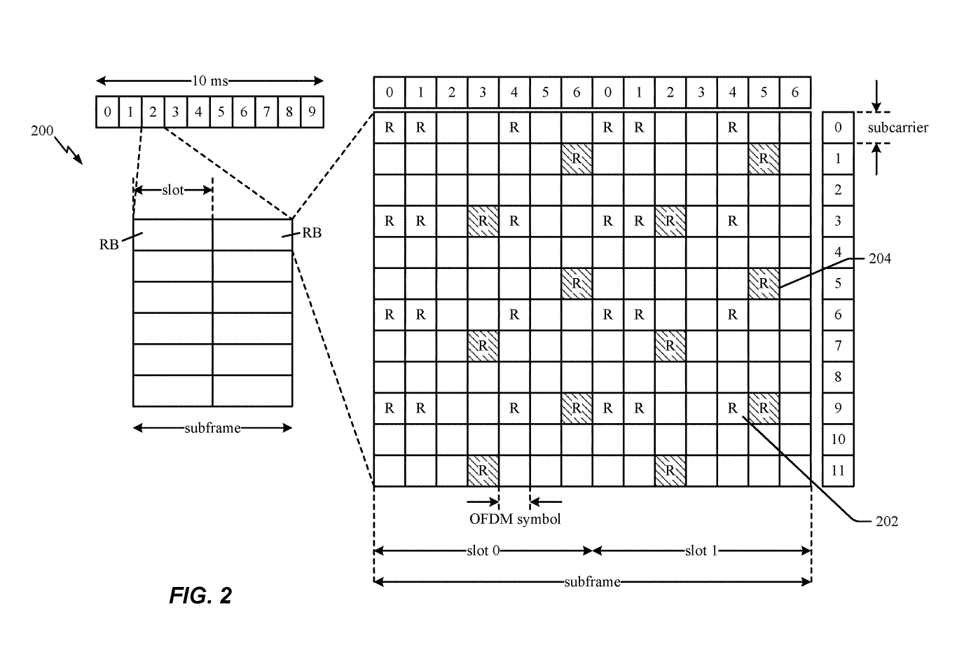

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each orthogonal frequency-division multiplexing (OFDM) symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204.

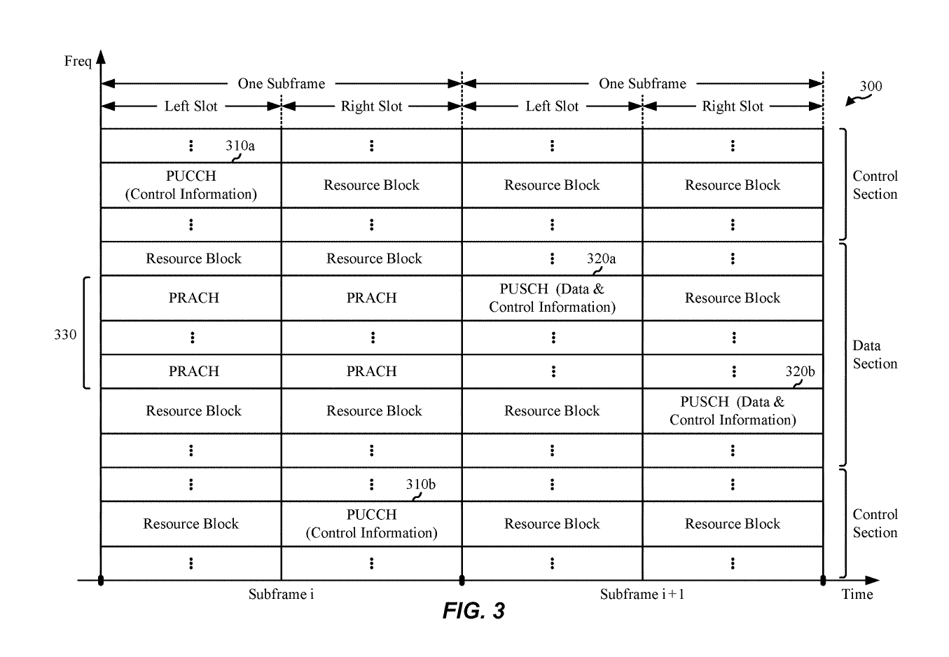

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. A set of resource blocks may be used to perform initial system access and achieve uplink synchronization in a physical random access channel (PRACH) 330.

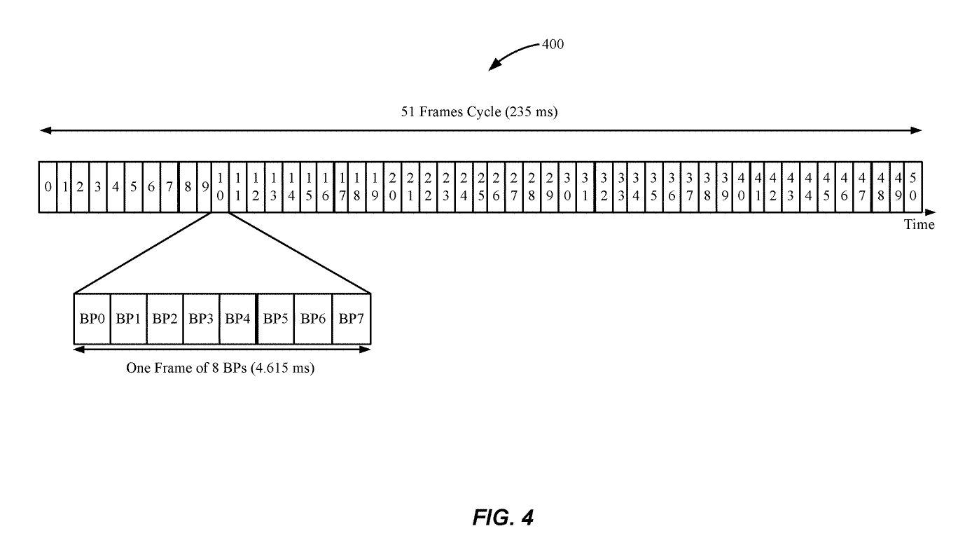

FIG. 4 is a block diagram illustrating an example of a GSM frame structure 400. The GSM frame structure 400 includes fifty-one frame cycles for a total duration of 235 ms. Each frame of the GSM frame structure 400 may have a frame length of 4.615 ms and may include eight burst periods, BP0-BP7.

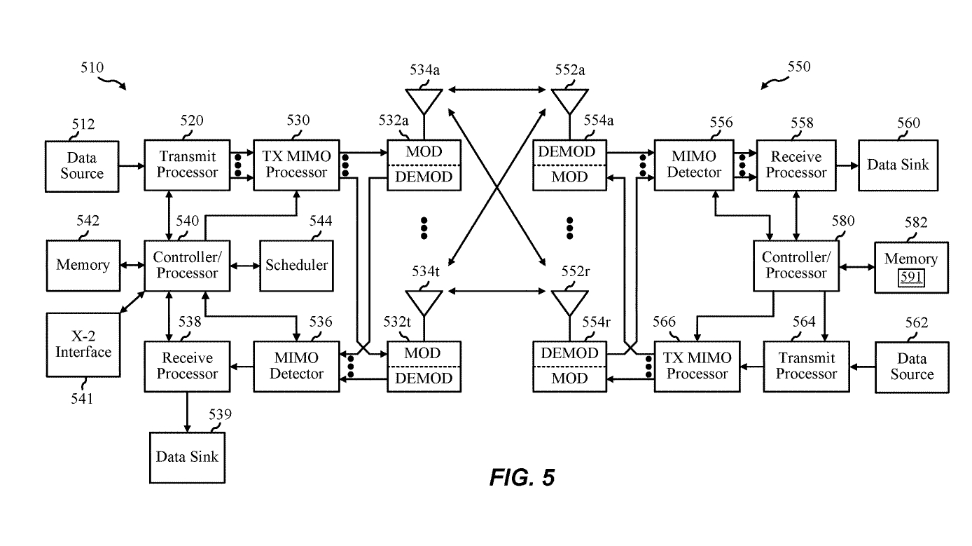

FIG. 5 is a block diagram of a base station (e.g., eNodeB or nodeB) 510 in communication with a UE 550 in an access network. In the downlink, upper layer packets from the core network are provided to a controller/processor 580. The base station 510 may be equipped with antennas 534a through 534t, and the UE 550 may be equipped with antennas 552a through 552r.

At the base station 510, a transmit processor 520 may receive data from a data source 512 and control information from a controller/processor 540. The processor 520 may process (e.g., encode and symbol map) the data and control information to obtain data symbols and control symbols, respectively. The processor 520 may also generate reference symbols, e.g., for the PSS, SSS, and cell-specific reference signal. A transmit (TX) multiple-input multiple-output (MIMO) processor 530 may perform spatial processing (e.g., precoding) on the data symbols, the control symbols, and/or the reference symbols, if applicable, and may provide output symbol streams to the modulators (MODs) 532a through 532t. Each modulator 532 may process a respective output symbol stream (e.g., for OFDM, etc.) to obtain an output sample stream. Each modulator 532 may further process (e.g., convert to analog, amplify, filter, and upconvert) the output sample stream to obtain a downlink signal. Downlink signals from modulators 532a through 532t may be transmitted via the antennas 534a through 534t, respectively.

At the UE 550, the antennas 552a through 552r may receive the downlink signals from the base station 510 and may provide received signals to the demodulators (DEMODs) 554a through 554r, respectively. Each demodulator 554 may condition (e.g., filter, amplify, downconvert, and digitize) a respective received signal to obtain input samples. Each demodulator 554 may further process the input samples (e.g., for OFDM, etc.) to obtain received symbols. A MIMO detector 556 may obtain received symbols from all the demodulators 554a through 554r, perform MIMO detection on the received symbols if applicable, and provide detected symbols. A receive processor 558 may process (e.g., demodulate, deinterleave, and decode) the detected symbols, provide decoded data for the UE 550 to a data sink 560, and provide decoded control information to a controller/processor 580.

On the uplink, at the UE 550, a transmit processor 564 may receive and process data (e.g., for the PUSCH) from a data source 562 and control information (e.g., for the PUCCH) from the controller/processor 580. The processor 564 may also generate reference symbols for a reference signal. The symbols from the transmit processor 564 may be precoded by a TX MIMO processor 566 if applicable, further processed by the modulators 554a through 554r (e.g., for single carrier-frequency division multiple access (SC-FDMA), etc.), and transmitted to the base station 510. At the base station 510, the uplink signals from the UE 550 may be received by the antennas 534, processed by the demodulators 532, detected by a MIMO detector 536 if applicable, and further processed by a receive processor 538 to obtain decoded data and control information sent by the UE 550. The processor 538 may provide the decoded data to a data sink 539 and the decoded control information to the controller/processor 540. The base station 510 can send messages to other base stations, for example, over an X2 interface 541.

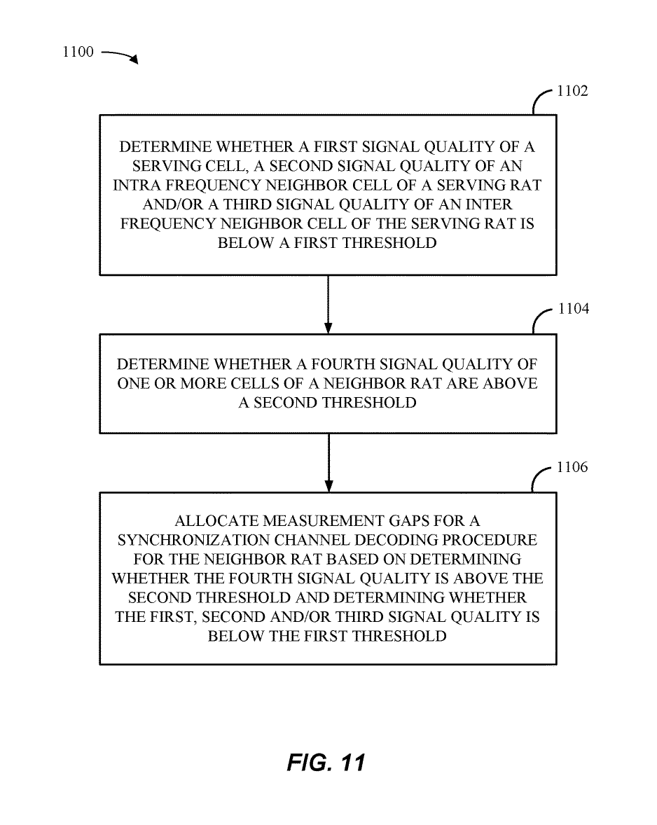

The controllers/processors 540 and 580 may direct the operation at the base station 510 and the UE 550, respectively. The processor 540/580 and/or other processors and modules at the base station 510/UE 550 may perform or direct the execution of the functional blocks illustrated in FIG. 11, and/or other processes for the techniques described herein. For example, the memory 582 of the UE 550 may store a measurement gap module 591 which, when executed by the controller/processor 580, configures the UE 550 to allocate measurement gaps according to one aspect of the present disclosure. The memories 542 and 582 may store data and program codes for the base station 510 and the UE 550, respectively. A scheduler 544 may schedule UEs for data transmission on the downlink and/or uplink.

In the uplink, the controller/processor 580 provides demultiplexing between transport and logical channels, packet reassembly, deciphering, header decompression, control signal processing to recover upper layer packets from the UE 550. Upper layer packets from the controller/processor 580 may be provided to the core network. The controller/processor 580 is also responsible for error detection using an acknowledgement (ACK) and/or negative acknowledgement (NACK) protocol to support HARQ operations.

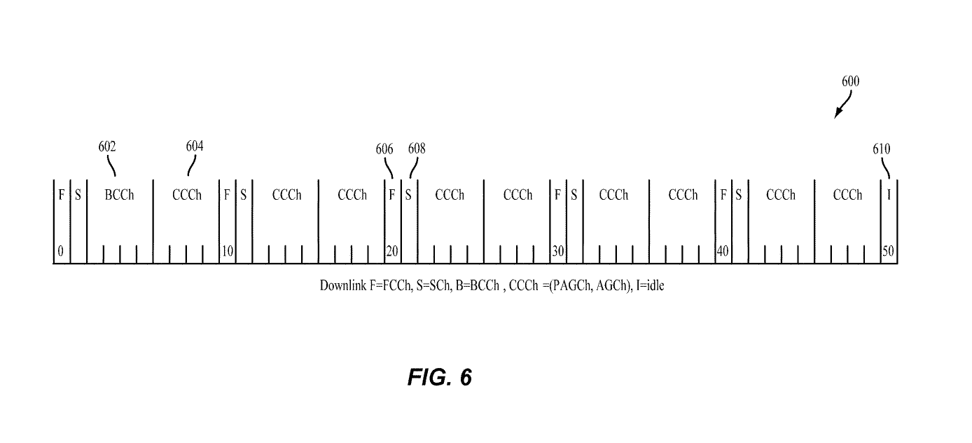

FIG. 6 is a block diagram 600 illustrating the timing of channels according to aspects of the present disclosure. The block diagram 600 shows a broadcast control channel (BCCH) 602, a common control channel (CCCH) 604, a frequency correction channel (FCCH) 606, a synchronization channel (SCH) 608 and an idle time slot 610. The numbers at the bottom of the block diagram 600 indicate various moments in time. In one configuration, the numbers at the bottom of the block diagram 600 are in seconds. In one configuration, each block of an FCCH 606 may include eight time slots, with only the first timeslot (or TS0) used for FCCH tone detection.

The timing of the channels shown in the block diagram 600 may be determined in a base station identity code (BSIC) identification procedure. The BSIC identification procedure may include detection of the FCCH carrier 606, based on a fixed bit sequence that is carried on the FCCH 606. FCCH tone detection is performed to find the relative timing between multiple RATs. The FCCH tone detection may be based on the SCH 608 being either a first number of frames or a second number of frames later in time than the FCCH 606. The first number of frames may be equal to 11+n·10 frames and the second number of frames may be equal to 12+n·10 frames. The dot operator represents multiplication and n can be any positive number. These equations are used to schedule idle time slots to decode the SCH. The first number of frames and the second number of frames may be used to schedule idle time slots in order to decode the SCH 608, in case the SCH 608 falls into a measurement gap or an idle time slot 610.

For FCCH tone detection in an inter-RAT measurement, the FCCH may fully or partially fall within the idle time slots of the first RAT (not shown). The UE attempts to detect FCCH tones (for example, such as the FCCH 606) on the BCCH carrier of the n strongest BCCH carriers of the cells in the second RAT. The strongest cells in the second RAT may be indicated by a measurement control message. In one configuration, n is eight and the n BCCH carriers are ranked in order of the signal strength. For example, a BCCH carrier may be ranked higher than other BCCH carriers when the signal strength of the BCCH carrier is stronger than the signal strength of the other BCCH carriers. The top ranked BCCH carrier may be prioritized for FCCH tone detection.

Each BCCH carrier may be associated with a neighbor cell in the second RAT. In some instances, the UE receives a neighbor cell list including n ranked neighbor cells from a base station of the first RAT, for example, in a measurement control message. The neighbor cells in the neighbor cell list may be ranked according to signal strength. In some configurations, the n ranked neighbor cells may correspond to the n strongest BCCH carriers, such that system acquisition of the neighbor cells includes FCCH tone detection of these BCCH carriers.

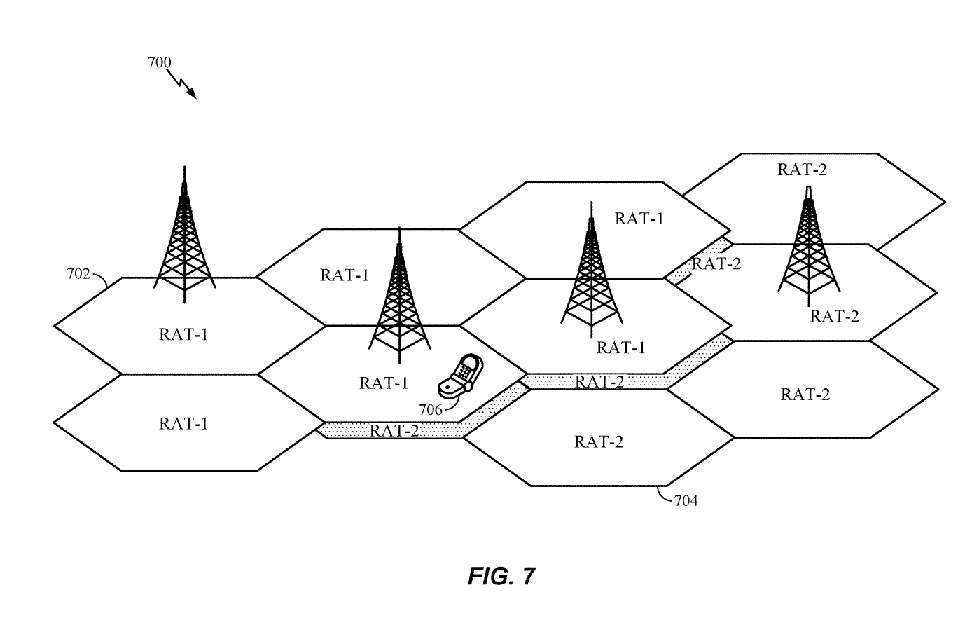

Some networks may be deployed with multiple radio access technologies. FIG. 7 illustrates a network utilizing multiple types of radio access technologies (RATs), such as but not limited to GSM (second generation (2G)), W-CDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 700 includes RAT-1 cells 702 and RAT-2 cells 704. In one example, the RAT-1 cells are 2G or 3G cells and the RAT-2 cells are LTE cells. However, those skilled in the art will appreciate that other types of radio access technologies may be utilized within the cells. A user equipment (UE) 706 may move from one cell, such as a RAT-1 cell 702, to another cell, such as a RAT-2 cell 704. The movement of the UE 706 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., LTE) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter-radio access technology (IRAT) measurement.

The UE may send to a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Ongoing communication on the UE may be handed over from the first RAT to a second RAT based on measurements performed on the second RAT. For example, the UE may tune away to the second RAT to perform the measurements. The UE may handover communications according to a single radio voice call continuity (SRVCC) procedure. SRVCC is a solution aimed at providing continuous voice services on packet-switched networks (e.g., LTE networks). In the early phases of LTE deployment, when UEs running voice services move out of an LTE network, the voice services can continue in the legacy circuit-switched (CS) domain using SRVCC, ensuring voice service continuity. SRVCC is a method of inter-radio access technology (IRAT) handover. SRVCC enables smooth session transfers from voice over internet protocol (VoIP) over the IP multimedia subsystem (IMS) on the LTE network to circuit-switched services in the universal terrestrial radio access network (UTRAN) or GSM enhanced date rates for GSM Evolution (EDGE) radio access network (GERAN).

LTE coverage is limited in availability. When a UE that is conducting a packet-switched voice call (e.g., voice over LTE (VoLTE) call) leaves LTE coverage or when LTE network is highly loaded, SRVCC may be used to maintain voice call continuity from a packet-switched (PS) call to a circuit-switched call during IRAT handover scenarios. SRVCC may also be used, for example, when a UE has a circuit-switched voice preference (e.g., circuit-switched fallback (CSFB)) and packet-switched voice preference is secondary if combined attach fails. The evolved packet core (EPC) may send an accept message for PS Attach in which case a VoIP/IMS capable UE initiates a packet-switched voice call.

A UE may perform an LTE serving cell measurement. When the LTE serving cell signal strength or quality is below a threshold (meaning the LTE signal may not be sufficient for an ongoing call), the UE may report an event 2A (change of the best frequency). In response to the measurement report, the LTE network may send radio resource control (RRC) reconfiguration messages indicating 2G/3G neighbor frequencies. The RRC reconfiguration message also indicates event B1 (neighbor cell becomes better than an absolute threshold) and/or B2 (a serving RAT becomes worse than a threshold and the inter-RAT neighbor becomes better than another threshold). The LTE network may also allocate LTE measurement gaps. For example, the measurement gap for LTE is a 6 ms gap that occurs every 40 or 80 ms. The UE uses the measurement gap to perform 2G/3G measurements and LTE inter-frequency measurements.

The measurement gap may be used for multiple IRAT measurements and inter-frequency measurements. The inter-frequency measurements may include measurements of frequencies of a same RAT (e.g., serving LTE). The IRAT measurements may include measurements of frequencies of a different RAT (e.g., non-serving RAT such as GSM). In some implementations, the LTE inter-frequency measurements and 3G IRAT measurements have a higher measurement scheduling priority than GSM.

Handover in conventional systems may be achieved by performing IRAT measurements and/or inter-frequency measurements. For example, the IRAT and/or inter-frequency searches and/or measurements include LTE inter-frequency searches and measurements, 3G searches and measurements, GSM searches and measurements, etc. followed by base station identity code (BSIC) procedures. The measurements may be attempted in measurements gaps that are inadequate (e.g., short duration such as 6 ms gap) for completion of the measurement procedure. In one instance, BSIC procedures may not be accomplished because a base station identification information does not fall within the short duration measurement gap. The BSIC procedures include frequency correction channel (FCCH) tone detection and synchronization channel (SCH) decoding that are performed after signal quality measurements.

When the base station identification information falls outside of the short duration measurement gap, the UE may be unable to detect the base station identification information and may be unable to synchronize with a target cell. For example, using a conventional 6 ms gap for every predefined time period (e.g., 40 ms or 80 ms), the base station identification information (e.g., FCCH and/or SCH) may not occur within the short duration measurement gap. That is, the FCCH and/or SCH do not occur during a remaining 5 ms gap after a frequency tuning period of 1 ms. If the UE is unable to detect the base station identification information communications may be interrupted. Further, repeated failed attempts by the UE may waste the UE's power.

The unpredictable failure of the FCCH/SCH to occur within the short duration measurement gap causes a variation of the IRAT measurement latency (e.g., increasing IRAT measurement latency). The failure of the FCCH/SCH to occur within the measurement gap may be due to a relative time between a serving RAT (e.g., LTE) and a neighbor RAT (e.g., GSM). The relative time impacts a time duration for the FCCH/SCH to fall into the 5 ms useful measurement gap (1 ms for frequency tuning). For example, the allocated time resources (e.g., frame timing) for the serving RAT and the neighbor RAT may be misaligned or offset, which causes failure of the FCCH/SCH to occur within the measurement gap of the serving RAT.

Because the UE may not be aware of the cause of the failure to detect the FCCH tone, for example, the UE may continue to attempt to detect the FCCH tone until an abort timer expires, which may cause delays in or interruptions to UE communications. For example, the UE may not be aware that the failure to detect the FCCH tone of the strongest frequency with the highest RSSI is due to low signal to noise ratio or FCCH occurring outside the measurement gap. As a result, the UE waits for an abort timer (e.g., 5 ms) to expire and then moves to the next strongest frequency. Waiting for expiration of the abort timer unnecessarily increase the IRAT measurement latency. However, if the UE aborts the FCCH tone detection prematurely, the UE may miss a chance of the FCCH occurring during the measurement gap.

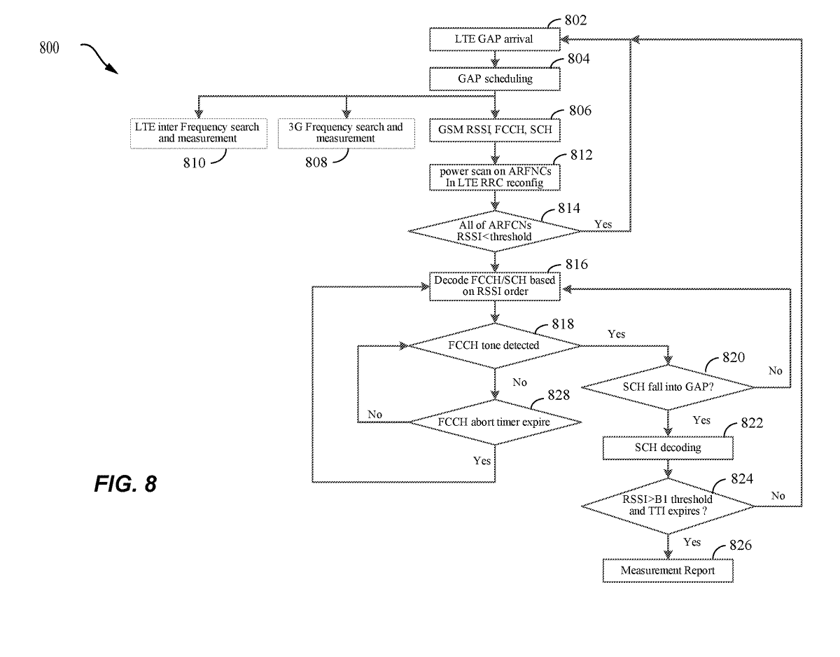

After the measurements, the UE may send a measurement report to the serving RAT. For example, the UE only sends the measurement report (e.g., B1 measurement report) after the completion of the BSIC procedures. Thus, the reporting of the results of the signal quality measurement, which occurs over a shorter period and which may occur on multiple occasions before the completion of the BSIC procedures, are delayed. Further, a transmission time interval (TTI) may expire prior to the completion of the BSIC procedures that result in an increase in latency or communication interruption. Measurement reports are transmitted to a network after the expiration of the TTI. Because the BSIC procedures are not complete, the measurement reports cannot be sent even when the TTI expires. An exemplary search and measurement procedure is illustrated in FIG. 8.

FIG. 8 is a flow diagram illustrating an example decision process for search and measurement of neighbor cells. The measurement may occur when the UE is on a first RAT (e.g., LTE) with a short duration measurement gap (e.g., 6 ms) every predefined period (e.g., 40 ms or 80 ms). The searches and measurements may include inter-frequency searches and measurements and inter-radio access technology (IRAT) searches and measurements. At block 802, measurement gap information transmitted by a network of the first RAT is received by the UE. For example, the measurement gap for LTE is a 6 ms gap that occurs every 40 or 80 ms. The UE uses the measurement gap to perform 2G/3G (e.g., TD-SCDMA and GSM) searches and measurements and LTE inter-frequency searches and measurements. A search and/or measurement schedule for the neighbor cells may be received by the UE from the network, as shown in block 804. The searches and measurements of the neighbor cells may be scheduled based on priority. For example, searches and measurements of LTE/TD-SCDMA neighbor cells or frequencies may have a higher priority than GSM neighbor cells. At blocks 806, 808 and 810, the UE performs inter-radio access technology (IRAT) and/or inter-frequency searches and/or measurements. The IRAT and/or inter-frequency searches and/or measurements include LTE inter-frequency searches and measurements, 3G searches and measurements, GSM searches, measurements and BSIC procedures, respectively, according to the schedule.

The user equipment performs measurements by scanning frequencies (e.g., power scan), as shown in block 812. The UE then determines whether a signal quality of a serving cell of a first RAT and the signal quality of neighbor cells meet a threshold, as shown in block 814. For example, it is determined whether the signal qualities (e.g., RSSIs) of the neighbor cells are less than the threshold. The threshold can be indicated to the UE through dedicated radio resource control (RRC) (e.g., LTE RRC reconfiguration) signaling from the network. When the signal quality of the neighbor cells fails to meet a threshold the process returns to block 802, in which the UE receives a next measurement gap information. However, when the signal qualities of one or more target neighbor cells meet the threshold, the UE continues to perform the BSIC procedures, as shown in block 816. The BSIC procedures may be performed on the target neighbor cells in order of signal quality. For example, the BSIC procedures may be performed on the cell with the best signal quality, followed by the cell with the second best signal quality and so on. The BSIC procedures include frequency correction channel (FCCH) tone detection and synchronization channel (SCH) decoding) that are performed after signal quality measurements.

In block 818, the UE may determine whether an FCCH tone is detected for a cell of the target cells (e.g., cell with best signal quality). If the FCCH tone is detected for the best cell, the UE determines whether the SCH falls into the measurement gap, as shown in block 820. In block 820, if the SCH does not fall into the measurement gap, the process returns to block 816, where the UE decodes FCCH/SCH for the target cell with the second best signal quality. However, if the SCH of the target neighbor cell with the best signal quality falls into the measurement gap, the UE performs SCH decoding, as shown in block 822. The UE then determines whether the signal quality of the target neighbor cell is greater than the threshold (e.g., B1 threshold) and whether the TTI has expired, as shown in block 824. If the TTI expired and the signal quality of the target neighbor cell is not greater than the threshold, the process returns to block 802, where the UE receives the measurement gap information. However, if the TTI expired and the signal quality of the target neighbor cell is greater than the threshold, the process continues to block 826, where the UE sends a measurement report to the network. As noted, measurement reports are transmitted to a network only after the expiration of the TTI, even when the other conditions, such as an RSSI being greater than the threshold are met.

When it is determined that the FCCH tone for the target neighbor cell is not detected at block 818, the process continues to block 828, where it is determined whether the FCCH abort timer expired. If the FCCH abort time is not expired, the process returns to block 818, where the UE continues to determine whether an FCCH tone is detected for the target neighbor cell. Otherwise, when it is determined that the FCCH abort timer expired at block 828, the process returns to block 816 where FCCH/SCH is decoded for the next target neighbor cell.

The BSIC procedures, which include frequency correction channel (FCCH) tone detection and synchronization channel (SCH) decoding) that are performed after signal quality measurements, may further cause a drain in the UE battery power. For example, the UE may repeatedly attempt to detect an FCCH tone or to decode SCH when the SCH/FCCH does not fall in an allocated measurement gap. The repeated attempts further drain the UE battery power.

Power savings is especially important to ensure improved battery life for packet-switched devices (e.g., VoLTE devices) where voice calls (voice over internet protocol calls) can be frequent and long. During the voice over internet protocol calls, voice packet arrivals may exhibit traffic characteristics that are discontinuous. A discontinuous reception (DRX) mechanism may be implemented to reduce power consumption based on the discontinuous traffic characteristics of the voice packet arrivals.

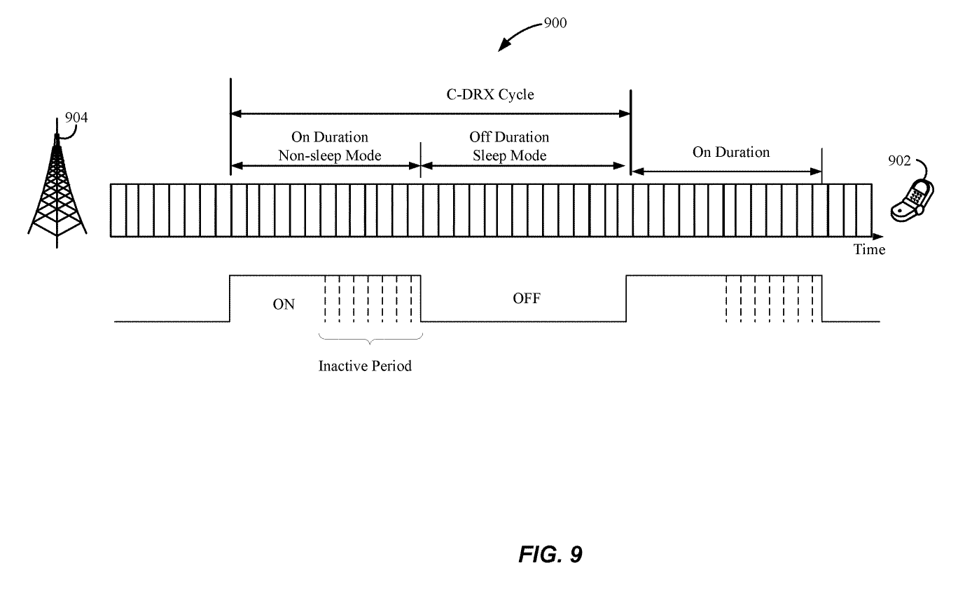

An exemplary discontinuous reception communication cycle 900 is illustrated in FIG. 9. The discontinuous reception cycle may correspond to a communication cycle where a user equipment (UE) 902 is in a connected mode (e.g., connected mode discontinuous reception (C-DRX) cycle). In the C-DRX cycle, the UE 902 may have an ongoing communication (e.g., voice call). For example, the ongoing communication may be discontinuous because of the inherent discontinuity in voice communications. The discontinuous communication cycle may also apply to other calls (e.g., multimedia calls).

The C-DRX cycle includes a time period/duration (e.g., C-DRX off duration) allocated for the UE 902 to sleep (e.g., sleep mode). In the sleep mode, the UE 902 may power down some of its components (e.g., receiver or receive chain is shut down). For example, when the UE 902 is in the connected state (e.g., RRC connected state) and communicating according to the C-DRX cycle, power consumption may be reduced by shutting down a receiver of the UE 902 for short periods. The C-DRX cycle also includes time periods when the UE 902 is awake (e.g., a non-sleep mode). The non-sleep mode may correspond to a time period (e.g., C-DRX on duration) allocated for the UE to stay awake. The C-DRX on duration includes a C-DRX on period and/or a C-DRX inactive period. The C-DRX on period corresponds to periods of communication (e.g., when the user is talking). The C-DRX inactive period, however, occurs during a pause in the communication (e.g., pauses in the conversation) that occurs prior to the C-DRX off duration.

The UE 902 enters the sleep mode to conserve energy when the pause in the communication extends beyond a duration of an inactivity timer. The inactivity timer may be configured by a network. The duration of the C-DRX inactive period is defined by the inactivity timer. For example, the UE 902 enters the sleep mode when the inactivity timer initiated at a start of the pause, expires. In some implementations, a duration of the inactivity timer and corresponding C-DRX inactive period, the C-DRX on period and the C-DRX off duration may be defined by the network. For example, the total DRX cycle may be 40 ms (e.g., one subframe corresponds to 1 ms). The C-DRX on period may have a duration of 4 subframes, the C-DRX inactive period may have a duration of 10 subframes and the C-DRX off duration may have a duration of 26 subframes.

During the time period allocated for the non-sleep mode, such as the C-DRX inactive period, the UE 902 monitors for downlink information such as a grant. For example, the downlink information may include a physical downlink control channel (PDCCH) of each subframe. The PDCCH may carry information to allocate resources for UEs 902 and control information for downlink channels. During the sleep mode, however, the UE 902 skips monitoring the PDCCH to save battery power. To achieve the power savings, a serving base station (e.g., eNodeB) 904, which is aware of the sleep and non-sleep modes of the communication cycle, skips scheduling downlink transmissions during the sleep mode. Thus, the UE 902 does not receive downlink information during the sleep mode and can therefore skip monitoring for downlink information to save battery power.

For example, when the UE is in the connected state and a time between the arrival of voice packets is longer than the inactivity timer (e.g., inactivity timer expires between voice activity) the UE transitions into the sleep mode. A start of the inactivity timer may coincide with a start of the C-DRX inactive period of an ongoing communication. The end of the inactivity timer may coincide with a start of the sleep mode or an end to the non-sleep mode provided there is no intervening reception of data prior to the expiration of the inactivity timer. When there is an intervening reception of data, the inactivity timer is reset.

In some implementations, the UE is awake during the time period (e.g., C-DRX off duration) allocated for the sleep mode. During the C-DRX off duration or during an allocated measurement gap, the UE performs activities or measurement procedures. For example, the UE performs neighbor RAT (e.g., global system for mobile (GSM)) signal quality measurements (inter-radio access technology (IRAT) measurements and/or inter-frequency measurements) for a list of frequencies (e.g., GSM ARFCNs). The measurement procedures also include synchronization channel decoding procedures that may be performed after the signal quality measurements of the neighbor cells. The synchronization channel decoding procedures include frequency correction channel (FCCH)/synchronization channel (SCH) decoding for multiple frequencies of the neighbor RAT based on an order of signal quality until an end of the C-DRX off duration. Different RATs may include different channels for synchronization or timing. For example, the channels for synchronization in wideband code division multiple access (WCDMA) include primary synchronization channel (PSCH) and secondary synchronization channel (SSCH).

Measurement gaps may be allocated by a network for measurement procedures. The measurement procedures may include IRAT measurements and/or inter-frequency measurements. The inter-frequency measurements may include measurement of frequencies of a same RAT (e.g., LTE). For example, the UE connected to a serving LTE RAT measures LTE neighbor frequencies. The IRAT measurements may include measurements of frequencies of a different RAT (e.g., GSM). For example, the UE connected to a serving LTE RAT measures frequencies of neighbor GSM RAT. Measurement gaps allocated for inter-frequency measurement of a serving RAT may be independent of measurement gaps allocated for IRAT measurement. The inter-frequency measurements include signal quality measurements. The IRAT measurements include signal quality measurements followed by synchronization channel decoding procedures or BSIC procedures. The synchronization channel decoding procedures include FCCH tone detection and SCH decoding.

For example, after signal quality measurements (e.g., RSSI measurements) are performed for all GSM frequencies (e.g., absolute radio frequency channel numbers (ARFCNs)), a UE performs FCCH tone detection only for a strongest GSM frequency during every measurement gap until an abort timer expires. The UE also continues to periodically perform inter-frequency measurements during the synchronization channel decoding procedures. During the FCCH tone detection, the UE detects the FCCH during the measurement gap. In some instances, however, the FCCH falls into or is received when an inter-frequency measurement is scheduled to occur in a same measurement gap. When this happens, the UE conventionally performs the inter-frequency measurement using the measurement gap because inter-frequency measurement has a higher priority than IRAT measurement and the corresponding FCCH tone detection. Performing the inter-frequency measurement instead of the FCCH tone detection may increase delay associated with IRAT measurement and increase call drops in a serving RAT (e.g., LTE) before handover to a target RAT (e.g., GSM).

Aspects of the present disclosure are directed to reducing delays associated with inter-radio access technology (IRAT) measurements and to reducing call drop in a serving RAT (e.g., long term evolution (LTE)) before handover to a target or neighbor RAT (e.g., global system for mobile (GSM)). After performing signal quality measurements in a measurement gap for one or more frequencies of a target radio access technology (RAT), a user equipment (UE) performs synchronization channel decoding procedures. For example, the UE performs FCCH tone detection for the strongest GSM frequency in a measurement gap. To reduce delays associated with IRAT measurements, a measurement gap, in some aspects, may be allocated for performing the synchronization channel decoding procedures for the neighbor RAT even when an inter-frequency measurement is scheduled to be performed in a same measurement gap as the synchronization channel decoding procedures. This may cause the inter-frequency measurements to be blocked or prevented from being performed in one or more of the measurement gaps when the measurement gaps are allocated for IRAT measurement.

In one aspect of the disclosure, one or more measurement gaps may be allocated for the synchronization channel decoding procedures based on a signal quality of a serving cell or frequency and/or one or more neighbor cells (e.g., intra frequency and/or inter frequency neighbor cells) of the serving RAT and a signal quality of one or more cells of the neighbor RAT. For example, the measurement gaps are allocated based on whether the signal qualities of one or more cells of the serving RAT (e.g., serving cell and/or neighbor cells of the serving RAT) are below a first threshold, and the signal quality of one or more cells of the neighbor RAT are above a second threshold.

The first threshold may be an own system threshold defined according to a B2 event indicated by a serving RAT network. The second threshold may be another system threshold defined in accordance with a B1 and/or B2 event indicated by the serving RAT network. As noted, a radio resource control (RRC) reconfiguration message indicates event B1 (neighbor cell becomes better than an absolute threshold) and/or B2 (a serving RAT becomes worse than a threshold and the inter-RAT neighbor becomes better than another threshold).

Some aspects of the disclosure include allocating fewer measurement gaps. In particular, when the signal qualities of one or more cells of the neighbor RAT are above the second threshold, the signal quality of the serving RAT is below the first threshold and the purpose of the IRAT measurement is for synchronization channel decoding procedures, the UE allocates fewer measurement gaps for inter-frequency measurement. For example, measurement gaps that would otherwise be allocated for the inter-frequency measurements are allocated for the IRAT measurements. Thus, inter-frequency measurements are blocked in these measurement gaps. For example, when the signal quality of a GSM cell (e.g., corresponding to the strongest GSM frequency) on which FCCH tone detection is to be performed is above the second threshold and the signal quality of the LTE serving and neighbor cells are below the first threshold, inter-frequency measurements are blocked from some measurement gaps. In other aspects, only a portion of the inter-frequency measurement gap is blocked. In other words, the inter-frequency measurement gap is shortened.

One aspect includes allocating a particular measurement gap for the synchronization channel decoding procedure when a synchronization channel for the neighbor RAT is expected to fall into the particular measurement gap based at least in part on history. The UE allocates other measurement gaps for inter-frequency measurement when the synchronization channel for the neighbor RAT is not expected to fall into the other measurement gaps based at least in part on history. In particular, the UE identifies a measurement gap that the UE expects to receive FCCH and/or SCH. For example, the UE identifies a measurement gap that the UE expects to receive the FCCH for FCCH tone detection and/or SCH for SCH decoding based on a record or history. The UE may store or record previous measurements of frequencies of neighbor cells in memory. The measurement history may include cell global identity (e.g., a serving cell global identity (CGI)) and target RAT timing and other communication information to determine the measurement gaps that an indication for FCCH tone detection and/or SCH decoding are expected (or measurement gaps with at least a high probability of the occurrence of the FCCH/SCH) to be received. The target RAT timing may be a relative time for one or more cells of the target/neighbor RAT. Based on the measurement history (e.g., history of previous synchronization channel decoding), the UE determines when to expect a next indication (or FCCH) for FCCH tone detection and/or a next indication (or SCH) for SCH decoding.

For example, the UE may expect to receive the indication for the FCCH tone detection and/or SCH decoding in measurement gap 97 of 100 measurement gaps when the measurement history indicates that one or more previous indications for FCCH tone detection and/or SCH decoding were received in measurement gap 97. In this case, the UE does not reduce the number of measurement gaps for the inter-frequency measurements. Rather, within the gaps allocated as described above, the UE allocates measurement gap 97 for FCCH tone detection and/or SCH decoding (as part of the IRAT measurement) and blocks scheduled inter-frequency measurement in measurement gap 97. The remaining measurement gaps (e.g., measurement gaps 1-96 and 98-100) may be allocated for the inter-frequency measurements and/or signal quality measurements.

In another aspect, the measurement gaps are allocated based on an amount of time remaining to complete the synchronization channel decoding procedure or an amount of time remaining before an expiration of an abort timer. The abort timer controls when to abort the synchronization channel decoding procedure. For example, after signal quality measurements (e.g., RSSI measurements) are performed for all GSM frequencies (e.g., absolute radio frequency channel numbers (ARFCNs)), the UE performs FCCH tone detection and/or SCH decoding only for a strongest GSM frequency during every measurement gap until an abort timer expires. The UE uses the abort timer (e.g., 10 s) to mitigate delays associated failure to decode the synchronization channel especially when the failure unknown to the UE. For example, the UE may not know if the failure is due to the synchronization channel not falling into a measurement gap or due to the low signal to noise ratio when the synchronization channel falls into the measurement gap. The UE starts the abort timer to limit the amount of time spent unsuccessfully decoding the synchronization channel for the strongest GSM frequency. After the failure and the expiration of the abort timer, the UE may choose a second strongest GSM frequency for synchronization channel decoding.

In yet another aspect, the measurement gaps are allocated based on a capability of the UE to perform the synchronization channel decoding procedure when only a portion of the indication for the FCCH tone detection and/or synchronization channel decoding falls in the measurement gap (e.g., a portion of synchronization channels). Some higher-end UEs support performing the synchronization channel decoding procedure when a percentage of the FCCH tone detection indication and/or synchronization channel indication occurs in the measurement gap. Other lower-end UEs do not support performing the synchronization channel decoding procedure when a portion of the FCCH tone detection indication and/or synchronization channel indication occurs in the measurement gap.

For example, a low-end UE can successfully decode a synchronization channel when a hundred percent of the synchronization channel decoding indication falls in the measurement gap. In one aspect, when the UE is a low-end UE the measurement gaps discussed above are allocated to ensure one hundred percent falls within the gaps based on starting positions and length of the gaps and the expected timing of the synchronization channel. A middle-end UE can successfully decode a synchronization channel when seventy five percent of the synchronization channel decoding indication falls in the measurement gap. In one aspect, when the UE is a middle-end UE the measurement gaps are allocated to ensure that at least seventy five percent falls within the gaps based on starting positions and lengths of the gaps and the expected timing of the synchronization channel. A high-end UE can successfully decode a synchronization channel when fifty percent of the synchronization channel decoding indication falls in the measurement gap. In one aspect, when the UE is a high-end UE the measurement gaps are allocated to ensure at least fifty percent falls within the gaps based on starting positions and lengths of the gaps and the expected timing of the synchronization channel.

In yet another aspect, the measurement gaps discussed above are allocated based on a current call establishment status and/or whether the UE and/or a network supports IRAT handover for a current phase of the current call establishment status. For example, voice over internet protocol (VoIP) call status includes a pre-alerting status, an alerting status, an in-call conversation status, before signaling bearer setup for voice over LTE (VoLTE) call and before data bearer setup. The pre-alerting status and alerting status may occur prior to the in-call conversation status. During the pre-alerting and alerting status, neither the network nor the UE may support IRAT handover. As a result, the UE may not allocate measurement gaps for IRAT measurement during the pre-alerting status and the alerting status if the network or the UE does not supporting IRAT handover for pre-alerting status and/or the alerting status. However, during the in-call conversation status the UE may support allocation of measurement gaps for the IRAT measurement.

In a further aspect of the disclosure, the UE allocates the measurement gaps discussed above based on whether the UE supports performing measurements during connected discontinuous reception (C-DRX) off duration and/or supports performing measurements with a second receiver or diversity receiver. For example, when the UE supports performing measurements during the C-DRX off duration, the UE may schedule some inter-frequency measurements and/or IRAT measurements during the C-DRX off duration. Scheduling the measurements during the C-DRX off duration mitigates measurement conflicts when an inter-frequency measurement is scheduled to be performed in a same measurement gap as the synchronization channel decoding procedures. Similarly, when the UE supports performing measurements with a second receiver or diversity receiver, the UE may schedule some inter-frequency measurements and/or IRAT measurements with the second receiver to mitigate the measurement conflicts. The first receiver may be engaged in normal mobile operations, for example, link maintenance.

In another aspect, the UE allocates the measurement gaps based on whether a UE (user equipment) supports performing measurements during a connected discontinuous reception (C-DRX) off duration and/or whether the UE supports performing serving RAT inter frequency measurement and/or IRAT measurement (inter-radio access technology measurement) with a second receiver. The first receiver may be engaged in normal mobile operations, for example, link maintenance.

In yet another aspect of the disclosure, the target RAT is determined based on a public land mobile network (PLMN) identifier of the target RAT and a recorded service type history. Upon identification of the target RAT, the UE allocates more of the measurement gaps discussed above for performing measurements for the target RAT and allocates fewer measurement gaps for at least one non-target RAT. The service type history may be stored in a memory of the UE as shown in Table 1. The serving RAT may be LTE and the neighbor RAT may be GSM, TD-SCDMA, WCDMA or CDMA2000. When a UE is in a voice over LTE (VoLTE) communication, some network operators may specify that the target RAT is GSM. In this case, the UE allocates more measurement gaps for performing measurements for the target GSM RAT and allocates fewer measurement gaps for TD-SCDMA, WCDMA or CDMA2000.

TABLE 1

| Service | Serving RAT | Target RAT | PLMN |
|---|---|---|---|
| VoLTE | LTE | GSM | OPERATOR 1 PLMN |
| VoLTE | LTE | WCDMA | OPERATOR 2 PLMN |
| VoLTE | LTE | EVDO | OPERATOR 3 PLMN |
| Data Service | LTE | TD-SCDMA | OPERATOR 4 PLMN |

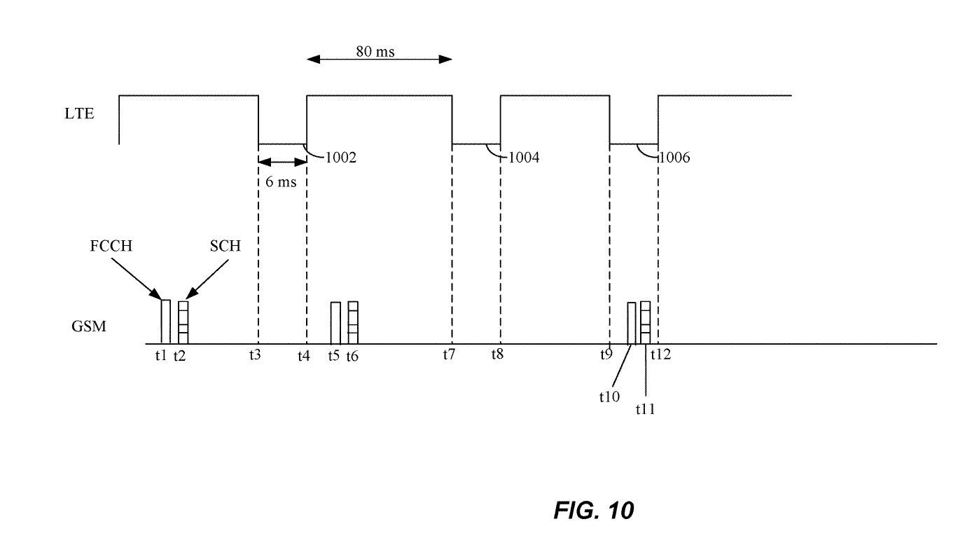

FIG. 10 illustrates a timeline for measurement gaps allocated by a network and a synchronization timeline indicating arrival of channels for synchronizing a user equipment (UE) to a target RAT. The target RAT may be GSM and the channels for synchronizing the UE may include a synchronization channel (SCH) and a frequency correction channel (FCCH). The serving network may be an LTE network and the measurement gap 1002 (between times t3 and t4), 1004 (between times t7 and t8) or 1006 (between times t9 and t12) may be a 6 ms gap that occurs every 80 ms. The UE uses the measurement gaps to perform IRAT measurements (e.g., GSM measurements) and inter-frequency measurements (e.g., LTE inter-frequency measurements).

It is noted that the FCCH and SCH at times t1, t2, t5, and t6 do not fall within any measurement gap. However, the synchronization channel decoding procedures may be performed in a measurement gap when the FCCH and/or SCH fall in the measurement gap (e.g., 1006) scheduled for inter-frequency measurement. For example, the synchronization channel decoding procedures may be performed in the measurement gap 1006 between time t9 and t12 because the FCCH and/or SCH (at times t10 and t11) fall in this measurement gap. In some instances, however, the measurement gap 1006 is already scheduled for inter-frequency measurement. In this case, the UE may allocate the measurement gap 1006 for the synchronization channel decoding procedures when the inter-frequency measurement is scheduled to be performed in the same measurement gap 1006 as the synchronization channel decoding procedures when the signal quality conditions are satisfied.

Performing the synchronization channel decoding procedures in place of the inter-frequency measurement effectively speeds up IRAT measurement and avoids call drop before handover from LTE to GSM.

FIG. 11 is a flow diagram illustrating a method 1100 for allocating measurement gaps according to one aspect of the present disclosure. The method reduces delays associated with inter-radio access technology (IRAT) measurements and to reducing call drop in a serving RAT (e.g., long term evolution (LTE)) before handover to a target or neighbor RAT (e.g., global system for mobile (GSM)). In some implementations, a user equipment (UE) reduces the delay by determining a first signal quality of a serving cell, a second signal quality of an intra frequency neighbor cell of a serving RAT (radio access technology), and/or a third signal quality of an inter frequency neighbor cell of the serving RAT is below a first threshold, as shown in block 1102. For example, the controller/processor 580 of the UE 550 of FIG. 5 determines whether the signal qualities are below the first threshold. At block 1104, the UE determines whether a fourth signal quality of one or more cells of a neighbor RAT is above a second threshold. For example, the controller/processor 580 of the UE 550 of FIG. 5 determines whether the signal qualities are below the first threshold. At block 1106, the UE allocates one or more measurement gaps for a synchronization channel decoding procedure for the neighbor RAT. The allocation is based on the determining whether the fourth signal quality is above the second threshold and on the determining whether the first, second, and/or third signal quality is below the first threshold. For example, the controller/processor 580 of the UE 550 of FIG. 5 determines whether the signal qualities are below the first threshold.

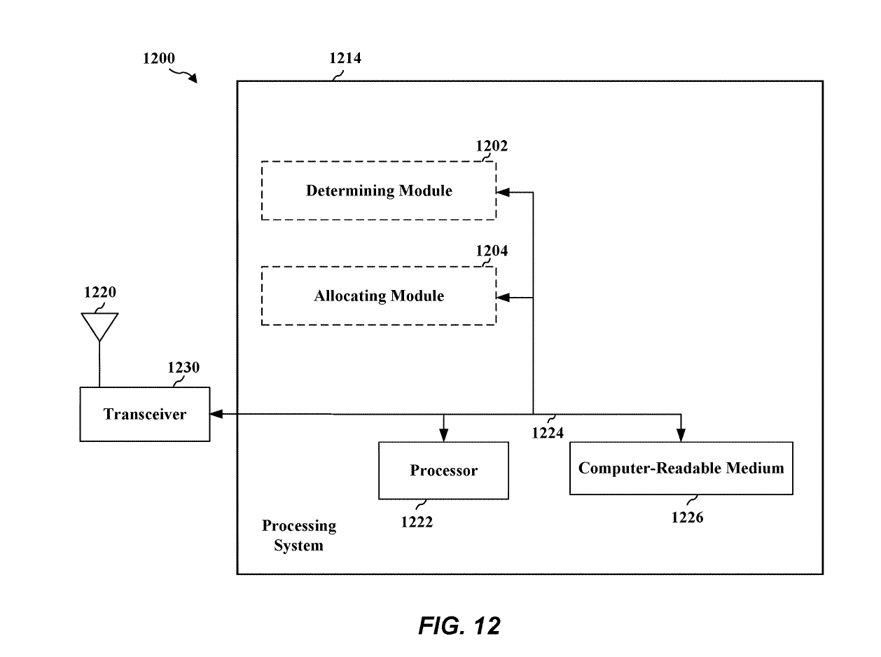

FIG. 12 is a diagram illustrating an example of a hardware implementation for an apparatus 1200 employing a processing system 1214 according to one aspect of the present disclosure. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1222, a determining module 1202, an allocating module 1204 and the non-transitory computer-readable medium 1226. The bus 1224 may also link various other circuits such as timing sources, peripherals, voltage regulators, and power management circuits, which are well known in the art, and therefore, will not be described any further.

The apparatus includes a processing system 1214 coupled to a transceiver 1230. The transceiver 1230 is coupled to one or more antennas 1220. The transceiver 1230 enables communicating with various other apparatus over a transmission medium. The processing system 1214 includes a processor 1222 coupled to a non-transitory computer-readable medium 1226. The processor 1222 is responsible for general processing, including the execution of software stored on the computer-readable medium 1226. The software, when executed by the processor 1222, causes the processing system 1214 to perform the various functions described for any particular apparatus. The computer-readable medium 1226 may also be used for storing data that is manipulated by the processor 1222 when executing software.

The processing system 1214 includes a determining module 1202 for determining whether a first signal quality of a serving cell, a second signal quality of an intra frequency neighbor cell of a serving RAT (radio access technology), and/or a third signal quality of an inter frequency neighbor cell of the serving RAT is below a first threshold. The determining module also determines whether a fourth signal quality of at least one cell of a neighbor RAT is above a second threshold. The processing system also includes an allocating module 1204 for allocating one or more measurement gaps for a synchronization channel decoding procedure for the neighbor RAT. The determining module 1202 and/or the allocating module 1204 may be software module(s) running in the processor 1222, resident/stored in the computer-readable medium 1226, one or more hardware modules coupled to the processor 1222, or some combination thereof. For example, when the determining module 1202 is a hardware module, the determining module 1202 includes the controller/processor 580. When the allocating module 1204 is a hardware module, the allocating module 1204 includes the controller/processor 580. The processing system 1214 may be a component of the UE 550 of FIG. 5 and may include the memory 582, and/or the controller/processor 580.

In one configuration, an apparatus, such as a UE 550, is configured for wireless communication including means for determining. In one aspect, the determining means may be the receive processor 558 of FIG. 5, the controller/processor 580 of FIG. 5, the memory 582 of FIG. 5, the measurement gap module 591 of FIG. 5, the determining module 1202 of FIG. 12, the processor 1222 of FIG. 12 and/or the processing system 1214 of FIG. 12 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus, such as a UE 550, is configured for wireless communication including means for allocating. In one aspect, the allocating means may be the receive processor 558 of FIG. 5, the controller/processor 580 of FIG. 5, the memory 582 of FIG. 5, the measurement gap module 591 of FIG. 5, the allocating module 1204 of FIG. 12, the processor 1222 of FIG. 12 and/or the processing system 1214 of FIG. 12 configured to perform the aforementioned means. In one configuration, the means functions correspond to the aforementioned structures. In another aspect, the aforementioned means may be a module or any apparatus configured to perform the functions recited by the aforementioned means.

In another configuration, an apparatus, such as a UE 550, includes a means for performing IRAT measurement. The performing means may include the processor 558, the controller/processor 580, the memory 582, and/or the processing system 1214 configured to perform the aforementioned means. The apparatus may also include a means for recording. The recording means may include the processor 558, the controller/processor 580, the memory 582, and/or the processing system 1214 configured to perform the aforementioned means. The apparatus may also include means for allocating measurement gaps. In particular, the allocating means may include means for allocating fewer measurement gaps, means for allocating other measurement gaps and/or means for allocating more measurement gaps. The allocating means may include the processor 558, the controller/processor 580, the memory 582, and/or the processing system 1214 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether a first signal quality of a serving cell, a second signal quality of an intra frequency neighbor cell of a serving RAT (radio access technology), and/or a third signal quality of an inter frequency neighbor cell of the serving RAT is below a first threshold;
determining whether a fourth signal quality of at least one cell of a neighbor RAT is above a second threshold; and
allocating at least one measurement gap for a synchronization channel decoding procedure for the neighbor RAT based at least in part on the determining whether the fourth signal quality is above the second threshold and determining whether the first, second, and/or third signal quality is below the first threshold.

2. The method of claim 1, further comprising performing an IRAT measurement (inter-radio access technology measurement) and allocating fewer than an available number of measurement gaps for inter-frequency measurement when the fourth signal quality is above the second threshold, at least one of the first, second, and third signal quality is below the first threshold, and a purpose of the IRAT measurement is for the synchronization channel decoding procedure.

3. The method of claim 2, in which performing the IRAT measurement includes performing signal quality measurement and the synchronization channel decoding procedure in the measurement gaps not allocated for the inter-frequency measurement.

4. The method of claim 1, further comprising:
recording a serving cell global identity (CGI) and a relative time for at least one cell of the neighbor RAT based at least in part on a previous synchronization channel decoding; and
determining when a synchronization channel for the neighbor RAT is expected to fall into a particular measurement gap based at least in part on the recording.

5. The method of claim 4, wherein the allocating comprises,
allocating the particular measurement gap for the synchronization channel decoding procedure when the synchronization channel for the neighbor RAT is expected to fall into the particular measurement gap based at least in part on past history; and
allocating other measurement gaps for inter-frequency measurement when the synchronization channel for the neighbor RAT is not expected to fall into the other measurement gaps based at least in part on past history.

6. The method of claim 1, wherein the allocating comprises allocating the measurement gaps further based at least in part on an amount of time remaining to complete the synchronization channel decoding procedure or time remaining before an abort timer expires for measuring a frequency of the neighbor RAT.

7. The method of claim 1, wherein the allocating comprises allocating the measurement gaps further based at least in part on a capability of a UE (user equipment) to perform the synchronization channel decoding procedure when a portion of synchronization channels occurs in one of the measurement gaps.

8. The method of claim 1, wherein the allocating comprises allocating the measurement gaps further based at least in part on whether a UE (user equipment) supports performing measurements during a connected discontinuous reception (C-DRX) off duration and/or whether performing inter frequency measurement of the serving RAT and/or performing IRAT measurement (inter-radio access technology measurement) with a diversity receiver is supported by the UE.

9. The method of claim 1, wherein the allocating comprises allocating the measurement gaps further based at least in part on a current call establishment status and/or whether a UE (user equipment) and/or a network supports IRAT handover for the current call establishment status.

10. The method of claim 1, further comprising:
determining a target RAT based at least in part on a public land mobile network (PLMN) identifier and a recorded service type history, wherein the allocating comprises
allocating more measurement gaps for the target RAT; and
allocating fewer measurement gaps for at least one non-target RAT.

11. An apparatus for wireless communication, comprising:
means for determining whether a first signal quality of a serving cell, a second signal quality of an intra frequency neighbor cell of a serving RAT (radio access technology), and/or a third signal quality of an inter frequency neighbor cell of the serving RAT is below a first threshold;
means for determining whether a fourth signal quality of at least one cell of a neighbor RAT is above a second threshold; and
means for allocating at least one measurement gap for a synchronization channel decoding procedure for the neighbor RAT based at least in part on the determining whether the fourth signal quality is above the second threshold and determining whether the first, second, and/or third signal quality is below the first threshold.

12. The apparatus of claim 11, further comprising means for performing an IRAT measurement (inter-radio access technology measurement) and means for allocating fewer than an available number of measurement gaps for inter-frequency measurement when the fourth signal quality is above the second threshold, at least one of the first, second, and third signal quality is below the first threshold, and a purpose of the IRAT measurement is for the synchronization channel decoding procedure.

13. The apparatus of claim 12, further comprising means for performing the IRAT measurement by performing signal quality measurement and the synchronization channel decoding procedure in measurement gaps not allocated for the inter-frequency measurement.

14. The apparatus of claim 11, further comprising:
means for recording a serving cell global identity (CGI) and a relative time for at least one cell of the neighbor RAT based at least in part on a previous synchronization channel decoding; and
means for determining when a synchronization channel for the neighbor RAT is expected to fall into a particular measurement gap based at least in part on the recording.

15. The apparatus of claim 11, wherein the allocating means further comprises:
means for allocating a particular measurement gap for the synchronization channel decoding procedure when a synchronization channel for the neighbor RAT is expected to fall into the particular measurement gap based at least in part on past history; and
means for allocating other measurement gaps for inter-frequency measurement when the synchronization channel for the neighbor RAT is not expected to fall into other measurement gaps based at least in part on past history.

16. An apparatus for wireless communication, comprising:
a memory;
a transceiver configured for wireless communication; and
at least one processor coupled to the memory and the transceiver, the at least one processor configured:
to determine whether a first signal quality of a serving cell, a second signal quality of an intra frequency neighbor cell of a serving RAT (radio access technology), and/or a third signal quality of an inter frequency neighbor cell of the serving RAT is below a first threshold;
to determine whether a fourth signal quality of at least one cell of a neighbor RAT is above a second threshold; and
to allocate at least one measurement gap for a synchronization channel decoding procedure for the neighbor RAT based at least in part on the determining whether the fourth signal quality is above the second threshold and determining whether the first, second, and/or third signal quality is below the first threshold.

17. The apparatus of claim 16, in which the at least one processor is further configured to perform an IRAT measurement (inter-radio access technology measurement) and to allocate fewer than an available number of measurement gaps for inter-frequency measurement when the fourth signal quality is above the second threshold, at least one of the first, second, and third signal quality is below the first threshold, and a purpose of the IRAT measurement is for the synchronization channel decoding procedure.

18. The apparatus of claim 17, in which the at least one processor is further configured to perform the IRAT measurement by performing signal quality measurement and the synchronization channel decoding procedure in the measurement gaps not allocated for the inter-frequency measurement.

19. The apparatus of claim 16, in which the at least one processor is further configured:
to record a serving cell global identity (CGI) and a relative time for at least one cell of the neighbor RAT based at least in part on a previous synchronization channel decoding; and
to determine when a synchronization channel for the neighbor RAT is expected to fall into a particular measurement gap based at least in part on the recording.

20. The apparatus of claim 16, in which the at least one processor is further configured to allocate by:
allocating a particular measurement gap for the synchronization channel decoding procedure when a synchronization channel for the neighbor RAT is expected to fall into the particular measurement gap based at least in part on past history; and
allocating other measurement gaps for inter-frequency measurement when the synchronization channel for the neighbor RAT is not expected to fall into the other measurement gaps based at least in part on past history.

21. The apparatus of claim 16, in which the at least one processor is further configured to allocate by allocating the measurement gaps based at least in part on an amount of time remaining to complete the synchronization channel decoding procedure or time remaining before an abort timer expires.

22. The apparatus of claim 16, in which the at least one processor is further configured to allocate by allocating the measurement gaps based at least in part on a capability of a UE (user equipment) to perform the synchronization channel decoding procedure when a portion of synchronization channels occurs in one of the measurement gaps.

23. The apparatus of claim 16, in which the at least one processor is further configured to allocate by allocating the measurement gaps based at least in part on whether a UE (user equipment) supports performing measurements during a connected discontinuous reception (C-DRX) off duration and/or whether performing inter frequency measurement of the serving RAT and/or performing IRAT measurement (inter-radio access technology measurement) with a second receiver is supported by the UE.

24. The apparatus of claim 16, in which the at least one processor is further configured to allocate by allocating the measurement gaps based at least in part on a current call establishment status and/or whether a UE (user equipment) and/or a network supports IRAT handover for the current call establishment status.

25. The apparatus of claim 16, in which the at least one processor is further configured:
to determine a target RAT based at least in part on a public land mobile network (PLMN) identifier and a recorded service type history;
to allocate more measurement gaps for the target RAT; and
to allocate fewer measurement gaps for at least one non-target RAT.

26. A non-transitory computer-readable medium having non-transitory program code recorded thereon, the program code comprising:
program code to determine whether a first signal quality of a serving cell, a second signal quality of an intra frequency neighbor cell of a serving RAT (radio access technology), and/or a third signal quality of an inter frequency neighbor cell of the serving RAT is below a first threshold;
program code to determine whether a fourth signal quality of at least one cell of a neighbor RAT is above a second threshold; and
program code to allocate at least one measurement gap for a synchronization channel decoding procedure for the neighbor RAT based at least in part on the determining whether the fourth signal quality is above the second threshold and determining whether the first, second, and/or third signal quality is below the first threshold.

27. The non-transitory computer-readable medium of claim 26, in which the program code is further configured to perform an IRAT measurement (inter-radio access technology measurement) and to allocate fewer than an available number of measurement gaps for inter-frequency measurement when the fourth signal quality is above the second threshold, at least one of the first, second, and third signal quality is below the first threshold, and a purpose of the IRAT measurement is for the synchronization channel decoding procedure.

28. The non-transitory computer-readable medium of claim 27, in which the program code is further configured to perform the IRAT measurement by performing signal quality measurement and the synchronization channel decoding procedure in the measurement gaps not allocated for the inter-frequency measurement.

29. The non-transitory computer-readable medium of claim 26, in which the program code is further configured:
to record a serving cell global identity (CGI) and a relative time for at least one cell of the neighbor RAT based at least in part on a previous synchronization channel decoding; and
to determine when a synchronization channel for the neighbor RAT is expected to fall into a particular measurement gap based at least in part on the recording.

30. The non-transitory computer-readable medium of claim 26, in which the program code is further configured to allocate by:
allocating a particular measurement gap for the synchronization channel decoding procedure when a synchronization channel for the neighbor RAT is expected to fall into the particular measurement gap based at least in part on past history; and
allocating other measurement gaps for inter-frequency measurement when the synchronization channel for the neighbor RAT is not expected to fall into the other measurement gaps based at least in part on history.
